(19) United States
(12) Patent Application Publication
(10) Pub. No.: US 2014/0178799 A1
(43) Pub. Date: Jun. 26, 2014

(54) SOLID OXIDE FUEL CELL AND MANUFACTURING METHOD THEREOF

(71) Applicant: SAMSUNG ELECTRO-MECHANICS CO., LTD., Suwon (KR)

(72) Inventors: Bon Seok Koo, Suwon (KR); Jong Sik Yoon, Suwon (KR); Jong Ho Chung, Suwon (KR); Sung Han Kim, Suwon (KR)

(73) Assignee: SAMSUNG ELECTRO-MECHANICS CO., LTD., Suwon (KR)

(21) Appl. No.: 13/830,509

(22) Filed: Mar. 14, 2013

(30) Foreign Application Priority Data
Dec. 21, 2012 (KR) 10-2012-0150566

(51) Int. Cl. H01M 8/02; H01M 8/00

(52) U.S. Cl. CPC H01M 8/025; H01M 8/00
USPC 429/508; 429/535

(57) ABSTRACT

Disclosed herein is a solid oxide fuel cell including a unit cell, wherein the unit cell includes: a cylindrical internal electrode: an interconnector having a T-shaped cross section and stacked on an outer peripheral surface of the internal electrode in a length direction; an electrolyte stacked on the outer peripheral surface of the internal electrode except for the interconnector; and an external electrode stacked on an outer peripheral surface of the electrolyte except for wing parts of the interconnector. In addition, disclosed herein is a manufacturing method of a solid oxide fuel cell.

### CROSS REFERENCE TO RELATED APPLICATION

This application claims the benefit of Korean Patent Application No. 10-2012-0150566, filed on Dec. 21, 2012, entitled “Solid Oxide Fuel Cell and Manufacturing Method thereof”, which is hereby incorporated by reference in its entirety into this application.

### BACKGROUND OF THE INVENTION

1. Technical Field

The present invention relates to a solid oxide fuel cell and a manufacturing method thereof.

2. Description of the Related Art

A fuel cell is a device directly converting chemical energy of a fuel (hydrogen, liquefied natural gas (LNG), liquefied petroleum gas (LPG), or the like) and air into electrical and thermal energy using an electrochemical reaction. The existing power generation technologies should perform processes such as fuel combustion, steam generation, turbine driving, power generator driving, or the like, while the fuel cell does not require the fuel combustion or a driving apparatus. As a result, the fuel cell is a new power generation technology capable of increasing power generation efficiency without causing environmental problems. This fuel cell minimally discharges air pollutants such as SO_{X}, NO_{X}, or the like, and generates less carbon dioxide, such that chemical-free, low-noise, non-vibration power generation, or the like, may be implemented.

There are various types of fuel cells such as a phosphoric acid fuel cell (PAFC), an alkaline fuel cell (AFC), a polymer electrolyte membrane fuel cell (PEMFC), a direct methanol fuel cell (DMFC), a solid oxide fuel cell (SOFC), or the like. Among them, the solid oxide fuel cell (SOFC) depends on activation polarization, which lowers over-voltage and irreversible loss to increase power generation efficiency. In addition, carbon or hydrocarbon based fuel as well as hydrogen may be used, such that fuel may be variously selected, and since the reaction rate in electrodes is rapid, the SOFC does not need to use expensive precious metals as an electrode catalyst. Further, heat additionally discharged during power generation has a high temperature and may be usefully used. The heat generated in the solid oxide fuel cell is used to reform fuel and used as an energy source for industry or cooling in cogeneration. Therefore, the solid oxide fuel cell is an essential power generation technology in order to enter a hydrogen economy society in the future.

A basic generation principle of the solid oxide fuel cell (SOFC) will be described below. The solid oxide fuel cell is a device generating power using oxidation reaction of hydrogen and CO, and electrode reactions as the following reaction formulas are carried out in an anode and a cathode.

Anode reaction: H₂+O²⁻→H₂O+2e⁻CO+O²⁻→CO₂+2e⁻

Cathode reaction: O₂+4e⁻→2O²⁻

Overall reaction: O₂+H₂+CO→H₂O+CO₂

That is, electrons are transferred to the cathode through an external circuit, and at the same time, oxygen ions generated in the cathode are transferred to the anode through an electrolyte, such that hydrogen or carbon monoxide (CO) is bonded to oxygen ions to generate electrons and water or carbon dioxide (CO₂) in the anode.

In a cylindrical or flat tubular solid oxide fuel cell according to the prior art, one portion of an outer peripheral surface thereof is provided with an interconnector for electrical connection as described above.

For example, a fuel cell configured of an anode supported tube, a coated interconnector formed so as to cross a central portion of a flat upper surface of the supported tube in a length direction, a coated electrolyte layer formed on an outer peripheral surface of the anode supported tube except for the interconnector, and a coated cathode on an outer peripheral surface of the electrolyte layer in a state in which the cathode is spaced apart from both sides of the interconnector by a predetermined distance has been disclosed in Korean Patent Laid-Open Publication No. 10-2005-0021027 (Patent Document 1).

The interconnector disclosed in Patent Document 1 has a rectangular cross-section so as to be in electrical communication with an upper or intermediate connection plate on the fuel cell.

Generally, the interconnector as described above is coated by a plasma spray coating method after removing the electrolyte layer. As described above, in the case in which adhesive force between both sides of the interconnector and sides of the electrolyte layer are not sufficiently secured, fuel gas flowing to the anode supported tube may be leaked.

Since the fuel gas and air flow in internal and external electrodes based on the electrolyte layer in the fuel cell, if the gas is leaked, output density of a unit cell may be significantly decreased, and unexpected ignition are generated while air and the fuel gas contact each other at a high temperature to increase an internal temperature in the fuel cell, thereby deteriorating durability of the entire fuel cell.

### PRIOR ART DOCUMENT

### Patent Document

(Patent Document 1) Korean Patent Laid-Open Publication No. 10-2005-0021027

### SUMMARY OF THE INVENTION

The present invention has been made in an effort to provide a solid oxide fuel cell capable of improving sticking force between an electrolyte and an interconnector.

According to a preferred embodiment of the present invention, there is provided a solid oxide fuel cell comprising a unit cell, wherein the unit cell includes: a cylindrical internal electrode: an interconnector having a T-shaped cross section and stacked on an outer peripheral surface of the internal electrode in a length direction; an electrolyte stacked on the outer peripheral surface of the internal electrode except for the interconnector; and an external electrode stacked on an outer peripheral surface of the electrolyte except for wing parts of the interconnector.

Both edges of the electrolyte may be formed with seat regions, wherein these seat regions contact lower surfaces of the wing parts of the interconnector having the T-shaped cross section.

Preferably, the seat region of the electrolyte may have a rough surface to improve sticking force between the electrolyte and the interconnector.

Particularly, both edges of the electrolyte may be formed with step parts in order to increase a contact area between the electrolyte and the interconnector.

A step surface of the step part, in other words, the seat region of the electrolyte may have a rough surface.

Both edges of the external electrode may be stacked on the outer peripheral surface of the electrolyte so as to be spaced apart from the interconnector by a predetermined interval.

Selectively, the unit cell may have a cylindrical or flat tubular structure.

In the unit cell, a cylindrical cathode, and the electrolyte and an anode on an outer peripheral surface of the cathode may be sequentially stacked, such that the cathode may form the internal electrode and the anode may form the external electrode.

Unlike this, in the unit cell, a cylindrical anode, and the electrolyte and a cathode on an outer peripheral surface of the anode may be sequentially stacked, such that the anode may form the internal electrode and the cathode may form the external electrode.

According to another preferred embodiment of the present invention, there is provided a manufacturing method of a solid oxide fuel cell, the manufacturing method including: providing a unit cell in which an internal electrode, an electrolyte, and an external electrode are sequentially stacked; exposing an outer peripheral surface of the electrolyte by removing a portion of the external electrode in a length direction of the unit cell; expose an outer peripheral surface of the internal electrode by removing a portion of the exposed outer peripheral surface of the electrolyte; and stacking an interconnector on the outer peripheral surface of the internal electrode and the removed portion of the electrolyte.

Preferably, the interconnector may be stacked to have a T-shaped cross section in the length direction of the unit cell.

The exposing of the outer peripheral surface of the internal electrode may further include forming a concave groove in the exposed outer peripheral surface of the electrolyte.

The manufacturing method may further include, after the forming of the concave groove, exposing the internal electrode by removing a portion of a bottom surface of the concave groove of the electrolyte so that a groove having a T-shaped cross section is formed in the electrolyte.

The external electrode and the electrolyte may be removed by a sand-blast process.

The exposed region of the electrolyte may have a rough surface.

The manufacturing method may further include stacking an insulating layer between the interconnector and the external electrode.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view schematically showing a cylindrical solid oxide fuel cell according to a preferred embodiment of the present invention;

FIG. 2 is a cross-sectional view taken along the line II-II of FIG. 1;

FIG. 3 is a structural view showing a state in which the cylindrical solid oxide fuel cells shown in FIG. 1 are stacked;

FIG. 4 is a cross-sectional view of a cylindrical solid oxide fuel cell according to another preferred embodiment of the present invention; and

FIG. 5 is a process flow chart sequentially showing manufacturing steps of the solid oxide fuel cell according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

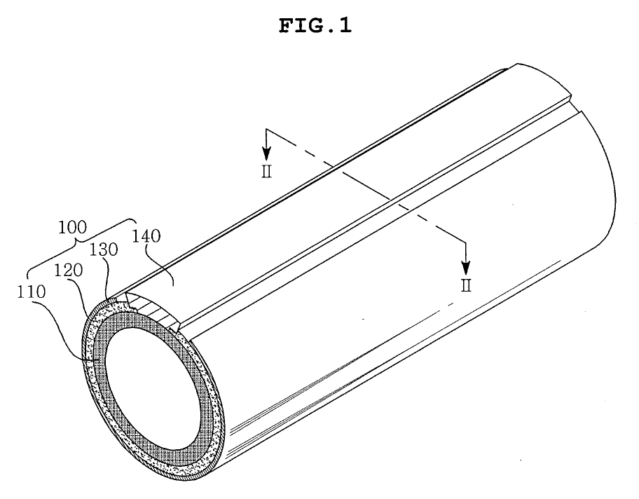

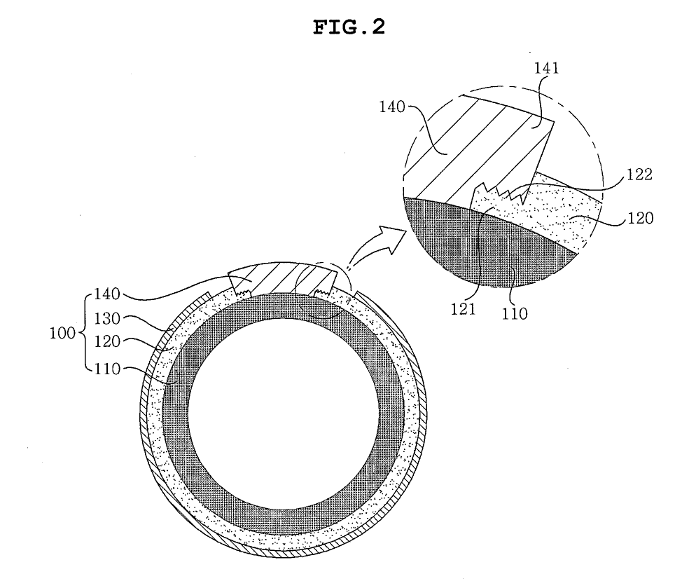

FIG. 1 is a perspective view schematically showing a cylindrical solid oxide fuel cell according to a preferred embodiment of the present invention, and FIG. 2 is a cross-sectional view taken along the line II-II of FIG. 1.

The solid oxide fuel cell according to the preferred embodiment of the present invention is configured of a unit cell 100 having a cylindrical shape, wherein the cylindrical unit cell 100 is configured of an internal electrode 110, an electrolyte 120, an external electrode 130, and an interconnector 140 as well known. More specifically, in the unit cell 100, the cylindrical internal electrode 110, the electrolyte 120 disposed on an outer peripheral surface of the cylindrical internal electrode 110, and the external electrode 130 disposed on an outer peripheral surface of the electrolyte 120 are sequentially provided from the center of the unit cell, and particularly, the interconnector 140 extended from one portion of the outer peripheral surface of the cylindrical internal electrode 110 in a length direction is provided.

The interconnector 140 is disposed to be space apart from the external electrode 130 by a predetermined interval. Selectively, the interconnector 140 protrudes outwardly from the outer peripheral surface of the internal electrode 110 in a radial direction and may protrude to be higher than the uppermost portion or outermost portion of the external electrode 130. This is to assist in connecting the interconnector 140 to another current collecting member 200 or the current collector.

As described above, in the unit cell 100, the internal electrode 110, the electrolyte 120, and the external electrode 130 are sequentially stacked. The unit cell 100 may be formed as an anode-supported fuel cell in which an anode (the internal electrode), the electrolyte, and a cathode (the external electrode) are sequentially stacked from the center of the unit cell. Alternatively, the unit cell 100 may be formed as a cathode-supported fuel cell in which the cathode (internal electrode), the electrolyte, and anode (external electrode) are sequentially stacked from the center. Although the anode-supported fuel cell is described in the present embodiment for convenience for explanation, the present invention is not limited thereto.

The anode of the cylindrical internal electrode 110 serves to support the electrolyte 120 and the cathode of the external electrode 130 to be stacked on the outer peripheral surface thereof. The anode is formed in a cylindrical shape and receives fuel (hydrogen) from a manifold to generate negative current through an electrode reaction.

Preferably, the anode is formed by heating nickel oxide (NiO) and yttria stabilized zirconia (YSZ) to 1200 to 1300° C., wherein nickel oxide is reduced to metallic nickel by hydrogen to exhibit electron conductivity, and yttria stabilized zirconia (YSZ) exhibits ion conductivity as an oxide.

The electrolyte 120, which assists oxygen ions generated in the cathode to be transferred to the anode, is stacked on an outer peripheral surface of the anode.

The electrolyte may be formed by performing the coating using a dry coating method such as a plasma spray method, an electrochemical deposition method, a sputtering method, an ion beam method, an ion implantation method, or the like, or a wet coating method such as a tape casting method, a spray coating method, a dip coating method, a screen printing method, a doctor blade method, or the like, and then performing the sintering at 1300 to 1500° C. The electrolyte 120 is formed on the outside of the anode using YSZ or scandium stabilized zirconia (ScSZ), gadolinia-doped ceria (GDC), La₂O₃-Doped CeO₂ (LDC), or the like, wherein since in the yttria stabilized zirconia, tetravalent zirconium ions are partially substituted with trivalent yttrium ions, one oxygen hole per two yttrium ions is generated therein, and oxygen ions move through the hole at a high temperature. Meanwhile, since the electrolyte 120 has low ion conductivity, voltage drop is less generated due to ohmic polarization. Therefore, it is preferable that the electrolyte is formed as thin as possible. If pores are generated in the electrolyte 120, since a crossover phenomenon of directly reacting fuel (hydrogen) with oxygen (air) may be generated, which reduces efficiency, it needs to be noted so that a scratch is not generated.

The cathode, which receives air (oxygen) from the outside at which an oxidation atmosphere is formed to generate positive current through the electrode reaction, is stacked on the outer peripheral surface of the electrolyte 120 as shown in FIG. 1. The cathode may be formed by coating lanthanum strontium manganite ((La_{0.84} Sr_{0.16}) MnO₃) having high electron conductivity, or the like, using a dry coating method or a wet coating method similar to that in the electrolyte, and then sintering the coated lanthanum strontium manganite at 1200 to 1300° C. That is, air (oxygen) is converted into oxygen ion by a catalytic action of lanthanum strontium manganite and transferred to the anode through the electrolyte 120.

The interconnector 140 is directly connected to one portion of an exposed outer peripheral surface of the internal electrode 110 as shown in FIG. 1 to transfer the negative current generated in the anode of the internal electrode 110 to the outside of the unit cell 100 (or a current collector). In other words, since the interconnector 140 is a member for collecting current of the internal electrode 110, the interconnector 140 needs to have electric conductivity.

In the unit cell 100, portions of the electrolyte 120 and the external electrode 130 are removed, thereby exposing a portion of the outer peripheral surface of the internal electrode 110. Next, the interconnector 140 is disposed on the exposed portion of the internal electrode 110. Since the interconnector 140 is in electrical communication with the internal electrode 110 as described above, in the case in which the interconnector contacts the external electrode 130, a short is generated. Therefore, the interconnector 140 and the external electrode 130 are arranged so as to be spaced apart from each other by a predetermined interval.

As widely known in those skilled in the art, the fuel gas and air flow in the internal and external electrodes 110 and 130 based on the electrolyte 120 in the unit cell 100. When the fuel gas flowing in a hollow part in the internal electrode 110 and air flowing to the outside of the external electrode contact each other due to a partial pressure difference in the unit cell 100, ignition is generated in the unit cell 100, such that durability of the solid oxide fuel cell may be deteriorated.

Therefore, the present invention suggests the interconnector 140 having a T-shaped cross section shown in the drawings. Step parts 121 are formed at both edges of the removed electrolyte 120 in the length direction of the unit cell so that the interconnector 140 having the T-shaped cross section is firmly seated on the electrolyte 120.

As shown, the interconnector 140 having the T-shaped cross section is stacked (or coated) on the exposed portion of the internal electrode 110 and both step parts 121 of the electrolyte 120 to increase a contact area between the electrolyte 120 and the interconnector 140, thereby improving sticking force. Therefore, the solid oxide fuel cell including the interconnector 140 having the T-shaped cross section may prevent the fuel gas in the internal electrode 110 from being leaked and the air in the external electrode from being introduced in the unit cell 100. A step surface formed by the step part 121, that is, a seat region 122 needs to have a width of 1 mm or more so as to secure the contact area between the step part 121 of the electrolyte 120 and the interconnector 140 having the T-shaped cross section. Here, the seat regions 122, which are both edges of the exposed electrolyte 120, mean portions on which lower surfaces of wing parts 141 of the interconnector 140 having the T-shaped cross section are seated to contact each other.

In addition, in order to assist the interconnector 140 to be seated on the electrolyte 120, the step part 121 and the interconnector 140 are formed to have the same curved shape, and more specifically, to have the same curvature as each other.

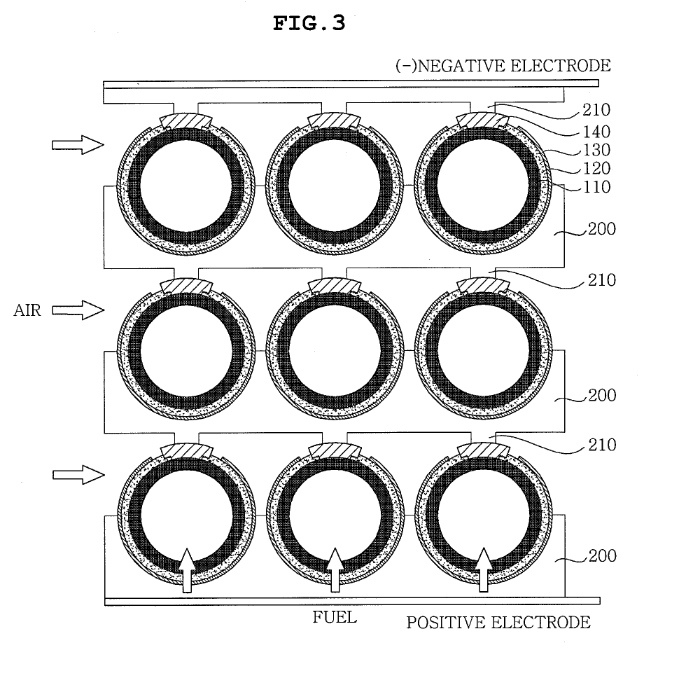

FIG. 3 is a structural view showing a state in which the cylindrical solid oxide fuel cells shown in FIG. 1 are stacked.

In a stack of the cylindrical solid oxide fuel cells according to the preferred embodiment of the present invention, a plurality of unit cells 100 are arranged in two or more rows and two or more columns, and current collectors 200 for connecting each of the unit cells 100 to each other are provided. Preferably, the current collectors 200 are arranged in parallel with each other at a predetermined interval so as to form air flow channels.

A lower surface of the current collector 200 forms a connection part 210 to maintain a state in which the lower surface is close to the interconnector 140, and an upper surface thereof is formed so as to contact the external electrode 130 of the unit cell 100.

In addition, in the solid oxide fuel cell, a stack electrode (no reference number) is connected to the current collector 200 disposed at the lowermost end, and another stack electrode is connected to the current collector 200 disposed at the uppermost end, such that an amount of power desired by an operator may be obtained.

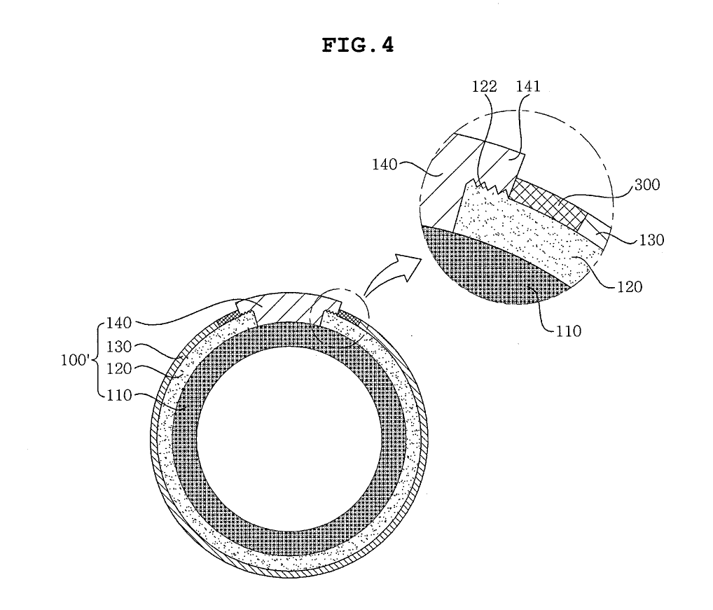

FIG. 4 is a cross-sectional view of a cylindrical solid oxide fuel cell according to another preferred embodiment of the present invention. Since the cylindrical solid oxide fuel cell shown in FIG. 4 has a significantly similar structure to that of the cylindrical solid oxide fuel cell shown in FIGS. 1 and 2 except for a shape of an electrolyte, in order to assist in the clear understanding of the present invention, a description of components that are similar to or the same as those in the above-mentioned cylindrical solid oxide fuel cell will be omitted.

Referring to FIG. 4, the solid oxide fuel cell according to the preferred embodiment of the present invention is configured of a unit cell 100′ having a cylindrical shape, wherein in the cylindrical unit cell 100′, after an internal electrode 110 formed as a supporter, an electrolyte 120, and an external electrode 130 are sequentially stacked, an interconnector 140 having a T-shaped cross section is formed. As described above, the interconnector 140 having the T-shaped cross section protrudes outwardly from one portion of an outer peripheral surface of the internal electrode 110 and contacts a current collector 200 (See FIG. 3) to serve to transfer the current generated in the internal electrode to the current collector.

Since the interconnector 140 is a member for current collection of the internal electrode 110, the interconnector 140 may be preferably made of a conductive material. In addition, the interconnector 140 may be arranged to be space apart from the external electrode 130 by a predetermined interval, or an insulating layer 300 may be additionally arranged between the interconnector 140 and the external electrode 130.

Preferably, wing parts 141 protruding from the interconnector 140 in a circumferential direction are stacked (or coated) on seat regions 122 of the electrolyte 120 having a rough surface, such that an exposed internal electrode 110 may be completely covered.

The electrolyte 120 does not include the step part 121 shown in FIGS. 1 and 2, but a body of the electrolyte 120 is removed, and outer peripheral surfaces of both edges of the electrolyte are formed with rough surfaces.

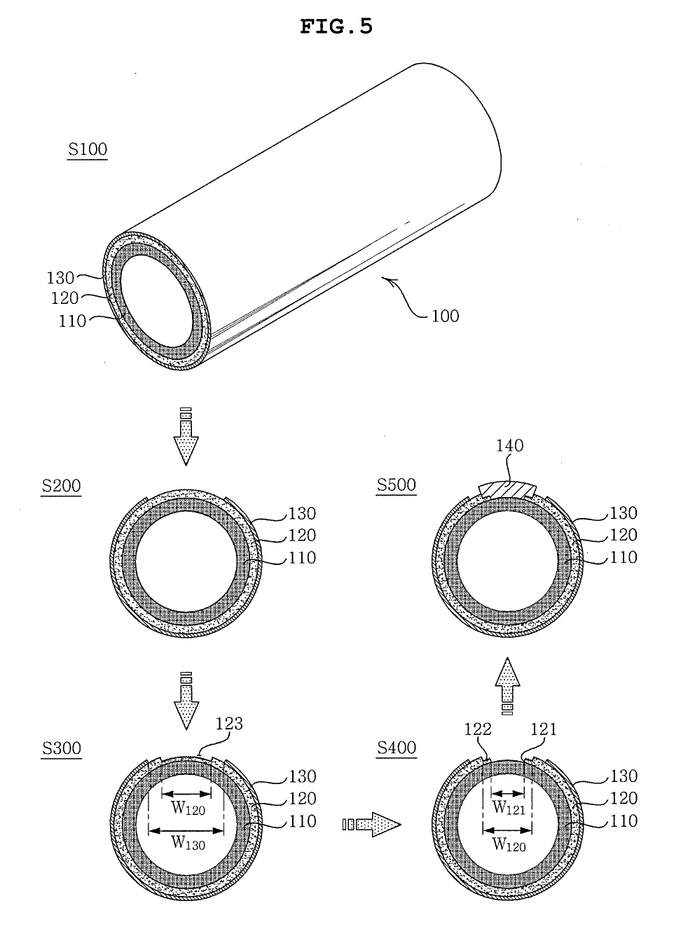

FIG. 5 is a process flow chart sequentially showing manufacturing steps of the solid oxide fuel cell according to the preferred embodiment of the present invention.

First, a manufacturing method of a solid oxide fuel cell according to the preferred embodiment of the present invention includes a step of providing a cylindrical or flat tubular unit cell 100 in which an internal electrode 110, an electrolyte 120, and an external electrode 130 are sequentially stacked (S100). Although the cylindrical unit cell is shown in FIG. 5, the present invention is not limited thereto, but may be applied to the flat tubular unit cell.

Next, the manufacturing method of a unit cell 100 according to the preferred embodiment of the present invention includes a step of removing a portion of the external electrode 130 in a length direction of the unit cell 100 (S200). Selectively, in S200, an outer peripheral surface of the electrolyte 120 of the unit cell 100 may be exposed using a sand-blast process, but the present invention is not limited thereto. The electrolyte 120 may be exposed by another method.

S300 is a step of removing a portion of the exposed surface of the electrolyte 120 in the length direction of unit cell 100. Selectively, in S300, the portion of the exposed surface of the electrolyte 120 may be removed by the sand-blast process similarly to in S200.

Particularly, while performing the step of removing the exposed portion of the electrolyte 120 (S300), the internal electrode 110 arranged at an inner side of the electrolyte 120 should not be exposed. In other words, in S300, the exposed portion of electrolyte 120 is not completely removed, but a thin and long concave groove 123 is formed on the exposed portion in the length direction of the unit cell 100.

Preferably, a width W₁₂₀ of the removed electrolyte 120 for forming the concave groove 123 may be narrower than a width W₁₃₀ of the exposed external electrode 130 in S200. The reason is to allow the interconnector 140 to be coated on the concave groove 123 of the electrolyte 120 and the external electrode 130 to be spaced apart from each other.

After forming the concave groove 123, the manufacturing method of a solid oxide fuel cell according to the preferred embodiment of the present invention includes a step of removing a portion of a bottom surface of the concave groove 123 in the length direction of the unit cell 100 (S400).

In S400, the portion (the unit cell according to the first preferred embodiment of the present invention) or the entire portion (the unit cell according to the second preferred embodiment of the present invention) of the bottom surface of the concave groove 123 of the electrolyte 120 is removed, thereby exposing the internal electrode 110.

Particularly, in removing the surface of the concave groove 123 in S400, both edges of the cut electrolyte 120 are formed with step parts 121 in the length direction of the unit cell 100.

Therefore, a spaced distance W₁₂₁ between the step parts 121 facing each other is narrower than the width W₁₂₀ of the concave groove 123 formed in S300, such that seating regions 122 may be secured at the both edges of the electrolyte 120 by a difference in the width W₁₂₀ and the spaced distance W₁₂₁. That is, each of the seating regions 122 may have a width of 1 mm or more. Here, the seat region 122 means a region between a side of the concave groove 123 and a side of the step part 121 and assist in seating the interconnector 140.

Preferably, the seat region 122 may have a rough surface by the above-mentioned sand-blast process. This rough surface may act as a means capable of improving the sticking force of the interconnector 140 to be coated on the concave groove 123 and the step part 121 of the electrolyte 120.

Then, the manufacturing method according to the preferred embodiment of the present invention includes a step of coating the interconnector 140 on the removed portion of the unit cell 100 (S500).

The interconnector 140 may fill an outer peripheral surface of the internal electrode 110, the step parts 121, the seat regions 122, and the concave groove 123 that are exposed in the length direction of the unit cell 100 to cover the unit cell 100, particularly, the region of the electrolyte 120 removed in a T shape. Therefore, the interconnector 140 may maintain a T-shaped cross section.

Particularly, the interconnector 140 may be further firmly stuck to the electrolyte 120 due to the rough surface formed on the removed portion by the sand-blast process.

Selectively, the interconnector 140 may be arranged so as not to contact the external electrode 130, and an insulating layer 300 (See FIG. 4) may be stacked between the interconnector 140 and the external electrode 130, as described above.

According to the present invention, in the cylindrical or flat tubular solid oxide fuel cell, the sticking force between the interconnector having the T shape and the electrolyte may be improved.

Particularly, according to the present invention, the contact area as well as the sticking force between the interconnector having the T shape and the electrolyte also may be increased, such that a contact between the gas flowing in the internal electrode and gas flowing around the external electrode may be certainly blocked.

Although the embodiments of the present invention have been disclosed for illustrative purposes, it will be appreciated that the present invention is not limited thereto, is and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A solid oxide fuel cell comprising a unit cell, wherein the unit cell includes:
a cylindrical internal electrode:
an interconnector having a T-shaped cross section and stacked on an outer peripheral surface of the internal electrode in a length direction;
an electrolyte stacked on the outer peripheral surface of the internal electrode except for the interconnector; and
an external electrode stacked on an outer peripheral surface of the electrolyte.

2. The solid oxide fuel cell as set forth in claim 1, wherein seat regions of the electrolyte are arranged so as to contact wing parts of the interconnector.

3. The solid oxide fuel cell as set forth in claim 2, wherein the seat region of the electrolyte has a rough surface.

4. The solid oxide fuel cell as set forth in claim 1, wherein both edges of the electrolyte are formed with step parts.

5. The solid oxide fuel cell as set forth in claim 4, wherein a seat region of the step part has a rough surface.

6. The solid oxide fuel cell as set forth in claim 1, wherein both edges of the external electrode are stacked on the outer peripheral surface of the electrolyte so as to be spaced apart from the interconnector by a predetermined interval.

7. The solid oxide fuel cell as set forth in claim 1, wherein the unit cell has a flat tubular structure.

8. The solid oxide fuel cell as set forth in claim 1, wherein in the unit cell, a cylindrical cathode, and the electrolyte and an anode on an outer peripheral surface of the cathode are sequentially stacked, the cathode forming the internal electrode, and the anode forming the external electrode.

9. The solid oxide fuel cell as set forth in claim 1, wherein in the unit cell, a cylindrical anode, and the electrolyte and a cathode on an outer peripheral surface of the anode are sequentially stacked, the anode forming the internal electrode, and the cathode forming the external electrode.

10. A manufacturing method of a solid oxide fuel cell, the manufacturing method comprising:
providing a unit cell in which an internal electrode, an electrolyte, and an external electrode are sequentially stacked;
exposing an outer peripheral surface of the electrolyte by removing a portion of the external electrode in a length direction of the unit cell;
exposing an outer peripheral surface of the internal electrode by removing a portion of the exposed outer peripheral surface of the electrolyte; and
stacking an interconnector on the outer peripheral surface of the internal electrode and the removed portion of the electrolyte.

11. The manufacturing method as set forth in claim 10, wherein the interconnector is stacked in a T shape in the length direction of the unit cell.

12. The manufacturing method as set forth in claim 10, wherein the exposing of the outer peripheral surface of the internal electrode further includes forming a concave groove in the exposed outer peripheral surface of the electrolyte.

13. The manufacturing method as set forth in claim 12, further comprising, after the forming of the concave groove, exposing the internal electrode by removing a portion of a bottom surface of the concave groove of the electrolyte so that a groove having a T-shaped cross section is formed in the electrolyte.

14. The manufacturing method as set forth in claim 10, wherein the external electrode and the electrolyte are removed by a sand-blast process.

15. The manufacturing method as set forth in claim 10, wherein the exposed region of the electrolyte has a rough surface.

16. The manufacturing method as set forth in claim 10, further comprising stacking an insulating layer between the interconnector and the external electrode.
